(19) United States
(12) Patent Application Publication
(10) Pub. No.: US 2014/0198446 A1
(43) Pub. Date: Jul. 17, 2014

(54) ELECTRONIC DEVICE WITH MEMORY SLOTS

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventor: XIAN-XIU TANG, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 13/846,950

(22) Filed: Mar. 19, 2013

(30) Foreign Application Priority Data
Jan. 17, 2013 (CN) 201310017153.2

(51) Int. Cl. G06F 1/16

(52) U.S. Cl. CPC G06F 1/16
USPC 361/679.32

(57) ABSTRACT

A memory slot defines a slot for receiving a memory card. Two resilient fixing members and a number of pins extend down from a bottom of the memory slot.

### BACKGROUND

1. Technical Field

The present disclosure relates to an electronic device including a plurality of memory slots.

2. Description of Related Art

Many memory slots are soldered on motherboards. When some of the memory slots do not need to be used, the memory slots cannot be disengaged from the motherboard to be reused elsewhere, which mean the memory slots will be wasted. Furthermore, those memory slots may block air flowing toward central processing units (CPUs).

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of an electronic device, wherein the electronic device includes a plurality of memory slots and a plurality of memory cards.

FIG. 2 is a partial, inverted view of one of the memory slots and one of the memory cards of FIG. 1.

FIG. 3 is an assembled, isometric view of FIG. 1.

FIG. 4 is cross-sectional view of FIG. 3, taken along the line IV-IV.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

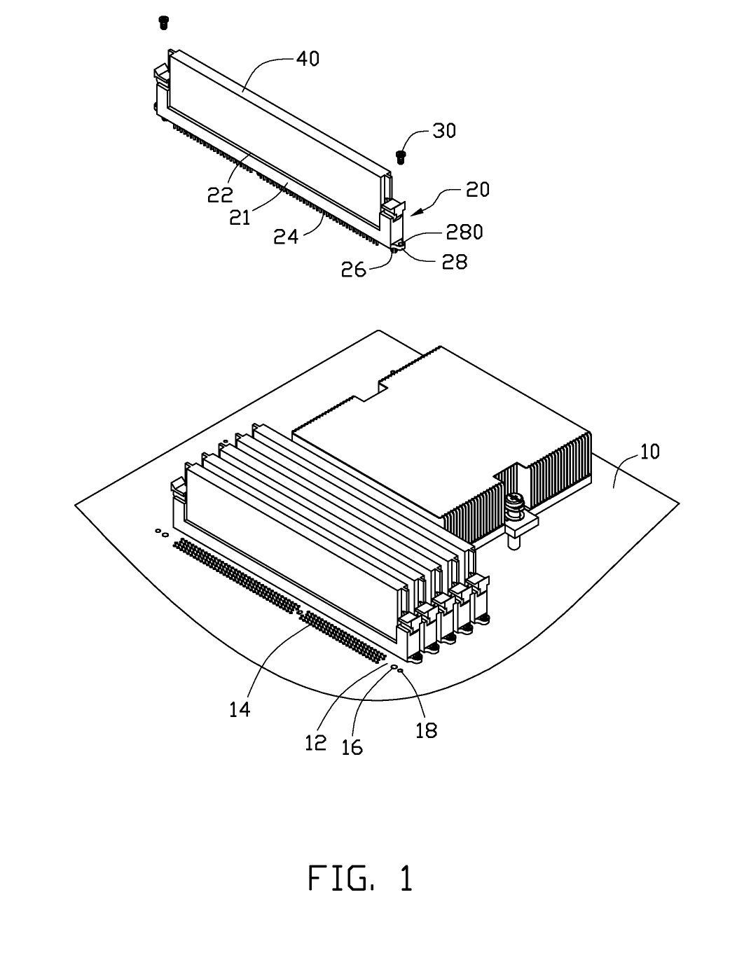

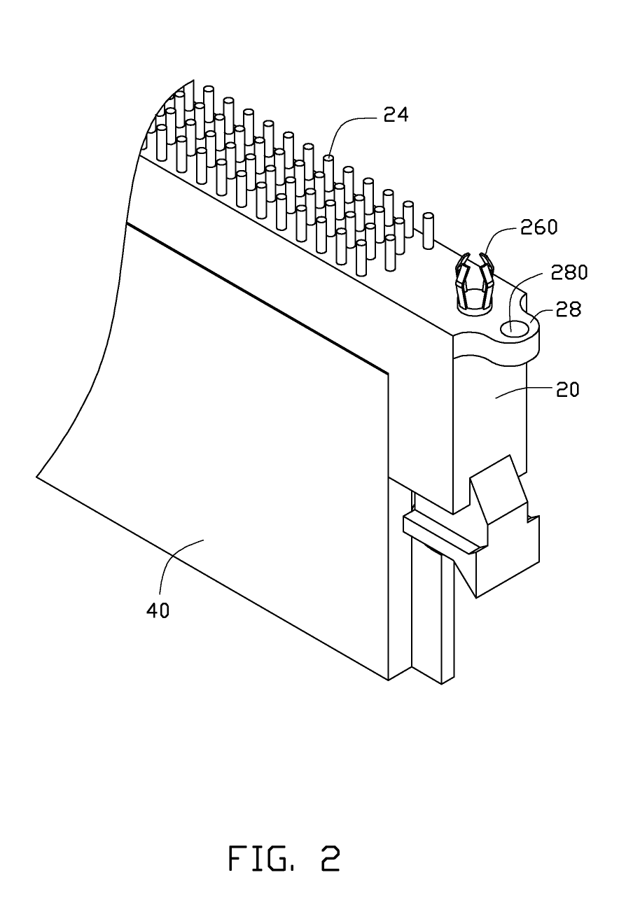

FIGS. 1 and 2 show an exemplary embodiment of an electronic device. The electronic device includes a motherboard 10, a plurality of memory slots 20, a plurality of memory cards 40, and a plurality of fasteners 30, such as screws.

Each memory slot 20 includes a main body 21 defining a slot 22 in a top to receive one of the memory cards 40, three fixing members 26 mounted to opposite ends and a center of a bottom of the main body 21, and a plurality of pins 24 extending down through the bottom of the main body 21 and extending into the slot 22 to be electrically connected to the corresponding memory card 40. Each fixing member 26 includes four substantially V-shaped resilient pieces 260 extending down from the memory slot 20 and then bending inward. Two extension portions 28 extend from opposite ends of the main body 21, each extension portion 28 defines a through hole 280 extending from top to bottom.

A plurality of installation areas 12 is formed on the motherboard 10. Each installation area 12 defines a plurality of engaging holes 14 corresponding to the pins 24 of a corresponding memory slot 20. Each installation area 12 further defines three fixing holes 16 corresponding to the fixing members 26 of the memory slot 20, and two fastening holes 18 corresponding to the through holes 280 of the memory slot 20. A sidewall bounding each engaging hole 14 is coated with copper.

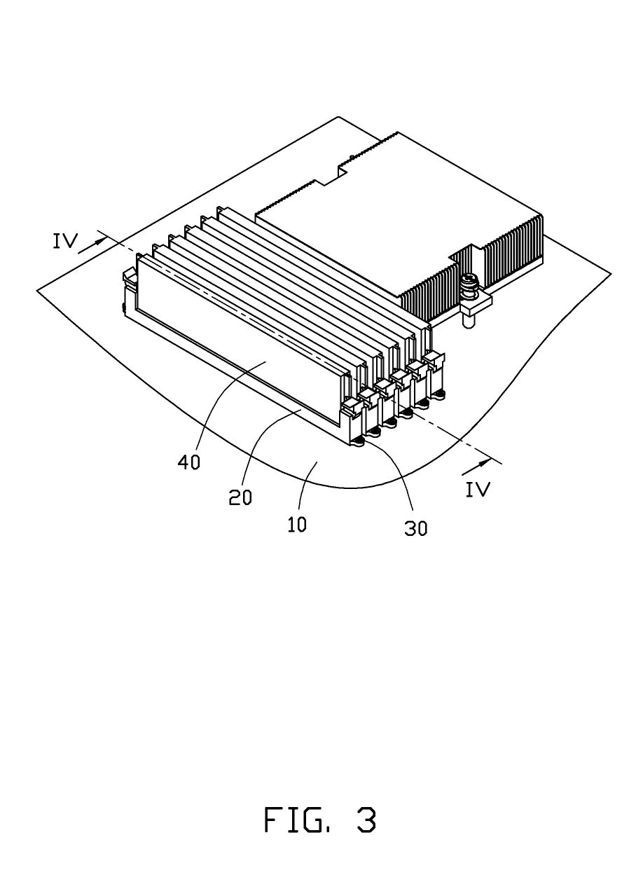

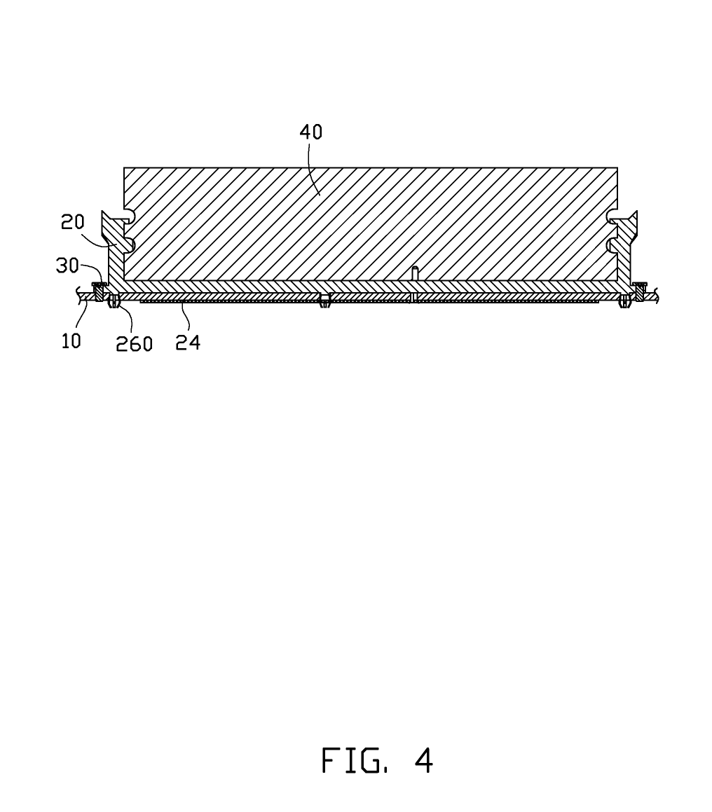

FIGS. 3 and 4 shows that in assembly, bottom ends of the pins 24 of each memory slot 20 are detachably engaged in the engaging holes 14 of one of the installation areas 12, thereby, electrically coupling the memory slot 20 to the motherboard 10. The resilient pieces 260 of each fixing member 26 are deformed inward to engage in a corresponding one of the fixing holes 16, until the bottom of the main body 21 contacts the motherboard 10, thereby fixing the memory slot 20 to the motherboard 10. The through holes 280 of the memory slot 20 are aligned with the fastening holes 18 of the corresponding installation area 12. Two fasteners 30 extend through the through holes 280 and then are engaged in the corresponding fastening holes 18. The memory card 40 received in the slot 22 is electrically connected to the motherboard 10 through the pins 24.

Because the memory slots 20 are detachably mounted to the motherboard 10, the number of the memory slots 20 can be changed as desired, which can save cost. Some of the memory slots 20 can be disengaged from the motherboard 10, to prevent airflow flowing toward the CPU from being blocked by those memory slots 20.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A memory slot, comprising:
a main body defining a slot in a top of the main body;
a plurality of pins extending through a bottom of the main body and extending into the slot; and
two flexible fixing members extending from the bottom of the main body.

2. The memory slot of claim 1, wherein each fixing member comprises two substantially V-shaped resilient pieces.

3. The memory slot of claim 1, wherein an extension portion extends from an end of the main body and defines a through hole.

4. An electronic device, comprising:
a motherboard defining a plurality of engaging holes and two fixing holes; and
a memory slot comprising a main body defining a slot in a top to receive a memory card, a plurality of pins extending through a bottom of the main body and extending into the slot to be electrically connected to the memory card, and two fixing members extending from a bottom of the main body, wherein the plurality of pins is detachably engaged in the corresponding engaging holes, the fixing members are detachably engaged in the fixing holes.

5. The electronic device of claim 4, wherein each fixing member comprises two substantially V-shaped resilient pieces.

6. The electronic device of claim 4, wherein an extension portion extends from an end of the main body and defines a through hole, a fastener extends through the through hole and engages in the motherboard.

7. The electronic device of claim 4, wherein a sidewall bounding each engaging hole is coated with copper.
